(19) United States
(12) Patent Application Publication
(10) Pub. No.: US 2017/0371886 A1
(43) Pub. Date: Dec. 28, 2017

(54) METHODS FOR IDENTIFYING CLUSTERS IN A DATASET, METHODS OF ANALYZING CYTOMETRY DATA WITH THE AID OF A COMPUTER AND METHODS OF DETECTING CELL SUB-POPULATIONS IN A PLURALITY OF CELLS

(71) Applicant: Agency for Science, Technology and Research, Singapore (SG)

(72) Inventors: Hao Chen, Singapore (SG); Jinmiao Chen, Singapore (SG)

(21) Appl. No.: 15/629,966

(22) Filed: Jun. 22, 2017

Related U.S. Application Data
(60) Provisional application No. 62/353,090, filed on Jun. 22, 2016.

(51) Int. Cl. G06F 17/30; G06K 9/62; G06F 17/18; G01N 15/10; G01N 15/14

(52) U.S. Cl. CPC G06F 17/3071; G06K 9/6226; G06F 17/18; G01N 2015/1402; G01N 2015/1006

(57) ABSTRACT

According to various embodiments, there is provided a method for identifying clusters in a dataset, the method including: determining for each data point in the dataset, a plurality of parameters including a first parameter and a second parameter, the first parameter being a distance between the data point and a nearest other data point having a local density that is higher than a local density of the data point, and the second parameter being a function of the local density of the data point and the first parameter; running statistical tests on each of the first parameter and the second parameter across the dataset, to identify outliers of the first parameter and outliers of the second parameter; and designating each data point where both the first parameter and the second parameter are identified outliers, as a centre of a respective cluster.

### CROSS-REFERENCE TO RELATED APPLICATIONS

This application claims the benefit of U.S. Provisional Patent Application No. 62/353,090 filed Jun. 22, 2016, the entire contents of which are incorporated herein by reference for all purposes.

### TECHNICAL FIELD

In some aspects, methods for identifying clusters in a dataset, methods of analyzing cytometry data with the aid of a computer and methods of detecting cell sub-populations in a plurality of cells, are disclosed.

### BACKGROUND

Cytometry, the measurement of cell characteristics, may be performed using various techniques. One of the techniques, single-cell mass cytometry, may provide several advantages over flow cytometry, such as detecting a large quantity of parameters per cell. The resulting measurements may be a high-dimensional dataset that provides unprecedented resolution to the cellular diversity of tissues that are being studied. However, the resulting measurements are technically challenging to analyze and interpret, owing to the high-dimensionality of the measurements.

### SUMMARY

According to various embodiments, a method for identifying clusters in a dataset may be provided. The method may include: determining for each data point in the dataset, a plurality of parameters including a first parameter and a second parameter, the first parameter being a distance between the data point and a nearest other data point having a local density that is higher than a local density of the data point, and the second parameter being a function of the local density of the data point and the first parameter; running statistical tests on each of the first parameter and the second parameter across the dataset, to identify outliers of the first parameter and outliers of the second parameter; and designating each data point where both the first parameter and the second parameter are identified outliers, as a centre of a respective cluster.

According to various embodiments, a method of analyzing cytometry data with the aid of a computer may be provided. The method may include: providing the computer with a dataset including the cytometry data; using the computer to identify clusters in the cytometry data, the clusters indicative of cell sub-populations, wherein identifying the clusters includes: determining for each data point in the dataset, a plurality of parameters including a first parameter and a second parameter, the first parameter being a distance between the data point and a nearest other data point having a local density that is higher than a local density of the data point, and the second parameter being a function of the local density of the data point and the first parameter; running statistical tests on each of the first parameter and the second parameter across the dataset, to identify outliers of the first parameter and outliers of the second parameter; and designating each data point where both the first parameter and the second parameter are identified outliers, as a centre of a respective cluster.

According to various embodiments, a method of detecting cell sub-populations in a plurality of cells, the method including: performing cytometry on the plurality of cells to detect a plurality of signals for each cell of the plurality of cells; recording in a dataset, the detected signals for the plurality of cells such that each data point in the dataset is associated with one cell of the plurality of cells; determining for each data point in the dataset, a plurality of parameters including a first parameter and a second parameter, the first parameter being a distance between the data point and a nearest other data point having a local density that is higher than a local density of the data point, and the second parameter being a function of the local density of the data point and the first parameter; running statistical tests on each of the first parameter and the second parameter across the dataset, to identify outliers of the first parameter and outliers of the second parameter; and designating each data point where both the first parameter and the second parameter are identified outliers, as a centre of a respective cluster, wherein each cluster is indicative of a cell sub-population.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a flow diagram of a method for determining parameters for each data point in a dataset, according to various embodiments.

FIG. 2 shows a work flow diagram of a method for identifying clusters in a dataset according to various embodiments.

FIG. 3 shows an illustration of the local density estimation process of the method of FIG. 2.

FIG. 4A shows a visual plot of an example dataset.

FIG. 4B shows a graph showing the first parameter δ plotted against the local density ρ, for the example dataset of FIG. 4A.

FIG. 4C shows a graph showing the second parameter θ plotted against the rank of local density ρ, for the example dataset of FIG. 4A.

FIG. 4D shows a graph showing the local density 112 plotted against the second parameter θ, for the example dataset of FIG. 4A.

FIG. 5 shows an illustration of the cluster assignment process of the method of FIG. 2.

FIG. 6 shows a conceptual diagram showing a method for identifying clusters in a dataset incorporating the split-apply-combine process, according to various embodiments.

FIG. 7 shows a schematic view of an analysis pipeline according to various embodiments.

FIG. 8 shows an example of the graphical user interface of a software package according to various embodiments.

FIG. 9 shows an example of a user interface of a web application according to various embodiments.

FIG. 10 shows a comparison of dimensionality reduction methods, as applied onto a CD14⁻CD19⁻ peripheral blood mononuclear (PBMCs) mass cytometry dataset.

FIG. 11 shows a comparison of dimensionality reduction methods, as applied onto a CD4⁺T cell mass cytometry dataset.

FIG. 12 shows a comparison of clustering performed by various clustering algorithms.

FIG. 13 shows a table showing the clustering results as compared to the manually gated population of the first dataset.

FIG. 14 shows the heatmaps of the median marker expression of clusters detected by ClusterX, DensVM and PhenoGraph.

FIG. 15 shows a flow diagram of a method for identifying clusters in a dataset, according to various embodiments.

FIG. 16 shows a flow diagram of a method of analyzing cytometry data with the aid of a computer, according to various embodiments.

FIG. 17 shows a flow diagram of a method of detecting cell sub-populations in a plurality of cells, according to various embodiments.

FIG. 18 shows a conceptual diagram of a computer system configured to perform the method of FIG. 15, or may be used to facilitate the methods of FIG. 16 or 17, according to various embodiments.

### DESCRIPTION

Embodiments described below may be combined, for example, a part of one embodiment may be combined with a part of another embodiment. Furthermore, it will be understood that the embodiments described below in context of the methods are analogously valid for the respective non-transitory computer-readable media, and vice versa.

It will be understood that any property described herein for a specific method may also hold for any method described herein. Furthermore, it will be understood that for any method described herein, not necessarily all the components or processes described must be enclosed in the method, but only some (but not all) processes may be enclosed.

In this context, the non-transitory computer-readable medium may include a memory. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

Various embodiments will now be described by way of non-limiting examples with reference to the figures.

Mass cytometry, also known as cytometry by time-of-flight (CyTOF) may offer a high-dimensional measurement of the characteristics of individual cells. Mass cytometry may combine the advantages of flow cytometry and mass spectrometry by utilizing antibodies conjugated to metal isotopes. Mass cytometry may discriminate cells bound to antibodies by the unique time-of-flight pattern of the metal isotopes, which allows for simultaneous analysis of more than 40 markers with minimal signal overlap between channels. Mass cytometry may be applied in mapping phenotypic heterogeneity of leukemia, inferring cellular progression and hierarchies, assessing drug immunogenicity, mechanistic studies of cellular reprogramming, etc. Despite the advantages of mass cytometry, effective analysis and interpretation of these high dimensional and large-scale datasets remain challenging. Traditional manual gating, a state of the art method of flow cytometry data analysis, is not practical for mass cytometry. In addition, automatic methods designed for flow cytometry data may not be suited for analyzing mass cytometry data, which contains a far larger amount of information than flow cytometry data.

According to various embodiments, a method may be provided to identify clusters in a dataset. The method may be used to analyze cytometry data, and may be used to detect cell sub-populations in a plurality of cells. The identified clusters may correspond to cell sub-populations, as each data point in the dataset may reflect a characteristic of a respective single cell of a tissue that is being analyzed. The method may include a first process of computing various parameters of every data point in the dataset. Computation of the various parameters may include computing the local density of each data point, followed by computing the distance of the data point to the nearest neighboring data point with a higher local density, followed by computing a function of the local density and the aforementioned computed distance. The local density of a data point may be a measure of the quantity of neighboring data points within vicinity of the data point, and how near the neighboring data points are to the data point. The method may further include a second process of detecting cluster centers in the dataset. Each cluster centre may indicate a point in one sub-population. Detecting the cluster centre may include running statistical tests on the computed parameters to identify anomalies in the computed parameters. The method may further include a third process of assigning all remaining data points, in other words, data points that are not cluster centers, to the various clusters denoted by the cluster centers. Each data point may belong to only one cluster.

According to various embodiments, the method described above may include an initial process preceding the first process. The initial process may include reducing the dimensionality of the dataset to obtain a two-dimensional or three-dimensional matrix. The resulting matrix may be referred herein as a dissimilarity matrix. The first process, second process and third process described above may be performed on the data points of the dissimilarity matrix. The initial process may further improve the efficiency of the method, as the dissimilarity matrix includes lesser dimensions and therefore, is faster to process.

According to various embodiments, the methods described above may further include a split-apply-combine process. The split-apply-combine process may further improve the efficiency of the method. The split-apply-combine process may first divide the dataset into small datasets before the first process or before the initial process. The second process of computing the parameters may then be performed for each small dataset, either in parallel or sequentially. The split-apply-combine process may include combining the computed parameters into a single matrix for performing the second process and third process of the method.

FIG. 1 shows a flow diagram of a method 100 for determining parameters for each data point in a dataset, according to various embodiments. The method 100 may include a density computation process 102. The density computation process 102 may include estimating the local density 112, ρᵢ of a data point i. The local density 112 may be indicative of the distances between the data point and its neighboring data points, as well as the quantity of neighboring data points. For example, a first data point with many neighboring data points that are close to the first data point may be considered to have a high local density 112. Conversely, a second data point that has few neighboring data points and these few neighboring data points are far away from the second data point, may be considered to have a low local density 112. The local density 112 of each data point may be collected for a delta computation process 104. The delta computation process 104 may include computing delta 114, denoted as δᵢ. The parameter delta 114 may be a minimum distance between the data point i and a nearest neighboring data point that has a higher local density 112 than the data point i. The delta computation process 104 may use the local densities 112 from the density computation process 102 to compute the delta 114. The method 100 may further include a theta computation process 106. For data point i, the theta computation process 106 may include receiving δᵢ from the delta computation process 104, and carrying out a function on δᵢ and ρᵢ to obtain theta 116, denoted as θᵢ. The density computation process 102, the delta computation process 104 and the theta computation process 106 may be carried out sequentially for the data point i. However, the density computation process 102, the delta computation process 104 and the theta computation process 106 may be carried out for other data points, for example, data point i+1 or i−1, in parallel to the density computation process 102, the delta computation process 104 and the theta computation process 106 for data point i.

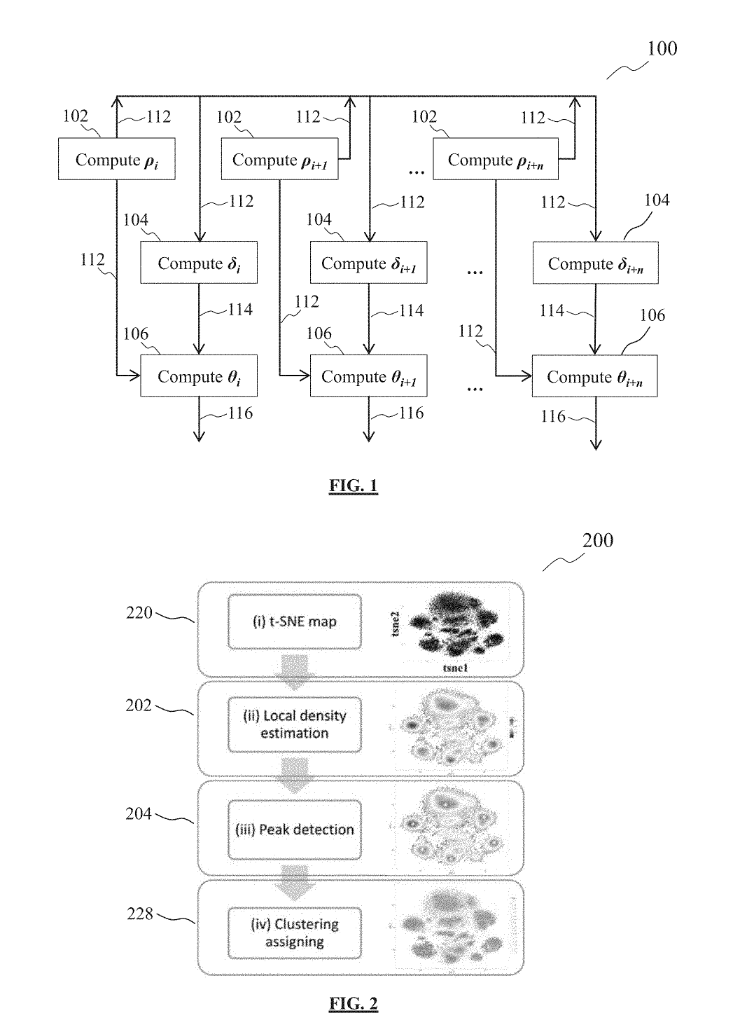

FIG. 2 shows a work flow diagram of a method 200 for identifying clusters in a dataset according to various embodiments. The dataset may include mass cytometry data that is collected for a tissue or a plurality of cells. Each data point in the dataset may correspond to one cell. The method 200 may include a dimensionality reduction process 220. The dimensionality reduction process 220 may include applying a dimensionality reduction algorithm such as t-Distributed Stochastic Neighbor Embedding (t-SNE) on the dataset to embed the cell data into a lower dimensional space, to obtain a two-dimensional or three-dimensional t-SNE map. The t-SNE map, also referred herein as a dissimilarity matrix, may retain the high dimensional relationships between the cells. The t-SNE map may be the dataset referred to in the method 100.

The method 200 may further include a local density estimation process 202, which may be identical to, or at least substantially similar to, the density computation process 102. The local density estimation process 202 may estimate the local density 112, ρ of each data point on the t-SNE map, using an exponential kernel of Equation (1). For data point i, its local density 112 may be defined as:

$${ρ}_{i} = {\sum }_{j \text{:} j \neq i} {e}^{- {( \frac{{d}_{ij}}{{d}_{c}} )}^{2}} \qquad Equation ( 1 )$$

where dᵢⱼ denotes the Euclidean distance between data points i and j, while d_{c} denotes the kernel bandwidth. By using the exponential kernel, data points closer to the data point i may contribute more to the local density 112 of point i as compared to data points further away from the data point i. The cutoff distance may be defined by d_{c}. The cutoff distance may be selected such that the average local density of all data points in the t-SNE map is in the one to two percentile range of the total number of data points.

The method 200 may further include a peak detection process 204. The peak detection process 204 may automatically detect the density peaks in the dataset. The density peaks may represent the cluster centers of the dataset. The peak detection process 204 may include determining the value of a first parameter, δᵢ, where i denotes the identity of the data point. The first parameter may also be referred herein as delta 114. The process of determining the value of the first parameter may be identical to, or at least substantially similar to, the delta computation process 104. δᵢ may be the minimum distance from data point i, to any other data point that has a higher local density 112, than the data point i. The first parameter δᵢ may be defined as follows:

$${δ}_{i} = \{ \begin{matrix}{min}_{j : j \neq i , {ρ}_{j} > {ρ}_{i}} ( {d}_{ij} ) , & if exists {ρ}_{j} > {ρ}_{i} \\ {max}_{j : j \neq i} ( {d}_{ij} ) , & if not exists {ρ}_{j} > {ρ}_{i}\end{matrix} \qquad Equation ( 2 )$$

where j may denote a neighboring data point. The determination of the first parameter for data point i may include comparing the local density 112 of the data point i and the local densities 112 of neighboring data points in the dataset. The determination process may start with comparing ρᵢ to the local density 112 of the nearest neighboring data point, and then move on to comparing the local density 112 of other neighboring data points in order of the distance between the neighboring data points from data point i. Alternatively, the determination process may simultaneously compare ρᵢ to each of ρ₁, ρ₂, . . . , ρn, and then select the nearest data point j that fulfils the condition of ρⱼ≧pᵢ, where n denotes the quantity of data points in the dataset. If none of the other data points has a higher local density 112 than ρᵢ, the first parameter may be defined as the distance between the data point i and the furthest other data point.

The peak detection process 204 may further include determining the value of a second parameter, θᵢ, where i denotes the identity of the data point. The second parameter may also be referred herein as theta 116. The second parameter may be defined as:

θᵢ=ρᵢ×δᵢ Equation (3)

The process of determining the value of the second parameter may be identical to, or at least substantially similar to, the theta computation process 106. By combining the local density 112 ρ and the first parameter 114 δ into the second parameter θ, data points with relatively high δ but low ρ may be “neutralized” to having a low value of θ, while data points with both high δ and high ρ may have an abnormally large value of θ. Density peaks in the dataset may have high local density 112 and relatively large distance to the nearest point with a higher local density. Therefore, the density peaks may be detected, at least in part, by detecting anomalous values of θ. The peak detection process 204 may further include detection of anomalous values, in other words, outliers, of θᵢ. The outliers of θ may be anomalously large as compared to other values of θ of other data points. The detection of anomalous values of θ may include running a statistical test on θ, for all of the data points in the dataset. In other words, the statistical test may analyze the values of θ₁, θ₂, . . . , θₙ. The statistical test may include at least one of the generalized Extreme Studentized Deviate Test (ESD) or the Q test. The statistical test may exclude the use of manually decided thresholds, which may be subjective and inaccurate. An example of the pseudo code for detecting anomalous values of θ using the generalised ESD test is as follows:

```
peakID = ()
f = 0
while(peakExist = TRUE)
  $R = \frac{max ( {θ}_{i} ) - \overline{θ}}{s} ;$
  Rid = (which (θᵢ = max(θᵢ));
  $p = 1 - \frac{α}{2 ( n - j - 1 )} ;$
  $λ = \frac{( n - j ) {t}_{p , v - j - 1}}{( n - j - 1 + {𝓁}_{p , v - j - 1}^{2} ) ( n - j + 1 )} ;$
  if (R > λ)
    add Rid to peakID;
    remove θ_{Rid} from θ;
    j = j + 1;
  else
    peakExist = FALSE;
```

where θ̅ denotes the mean of θ; s denotes the standard deviation of θ; and t_{p,ν} denotes the 100p percentage point from the t-distribution with ν degree of freedom. In a dataset with very large number of data points, i.e. the quantity of cells is very large, the value of θ may be distorted by the large value of ρ. For example, a data point with a disproportionately large value of ρ may have a significantly large θ even if its value of δ is tiny. Such a data point may potentially be detected as a false cluster centre, if the identification of clusters relies solely on detecting anomalies of θ. The peak detection process 204 may further include detection of anomalous values, in other words, outliers, of δ. The outliers of δ may be anomalously large as compared to other values of δ of other data points. The detection of anomalous values of δ may include applying a statistical test to δ. The statistical test used may be the same statistical test applied to identify anomalies of the second parameter. In the statistical tests, the significance level used may be a common value, such as 0.01. The peak detection process 204 may further include intersecting the two sets of anomalies from both θ and δ. In other words, data points that have anomalous values for both θ and δ may be identified. These identified data points may be identified as density peaks, or in other words, cluster centers.

A conventional clustering algorithm may plot a decision graph which shows all δ values plotted against ρ. The conventional clustering algorithm may ask for a manual decision of the threshold to determine anomalous values of δ in the decision graph. The conventional clustering algorithm may then determine the data points that are cluster centers, based on the anomalous values of δ.

By computing the first parameter, the second parameter and identifying their outliers by running the statistical tests as described with respect to method 200, the cluster centers may be identified accurately and automatically. Accordingly, an improvement over the conventional approach to cluster identification may be realized without manual intervention and/or setting of arbitrary thresholds. By contrast, conventional clustering algorithms may request a user to manually input a threshold in determining a cluster location.

The method 200 may further include a cluster assignment process 228, which may include assigning each data point to its appropriate cluster, taking into considering the distance between neighboring data points and the local densities 112 of the neighboring data points. The cluster assignment process 228 may include representing the density peaks, in other words, initializing each cluster centre identified from the peak detection process 204 with a unique cluster identity. The cluster assignment process 228 may further include assigning each remaining data point to the same cluster as its nearest neighbor having a higher local density 112. The remaining data points may be the data points that are not identified as cluster centers. The assignment may be performed according to Equation (4):

$${C}_{i} = \{ \begin{matrix}rank of i in peakID ; & if i ∈ peakID \\ {C}_{j} , j \text{:} {ρ}_{j} > {ρ}_{i} {d}_{ij} = {min}_{k : k \neq l} {d}_{ik} ; & i f i ∉ peak ID\end{matrix} \qquad Equation ( 4 )$$

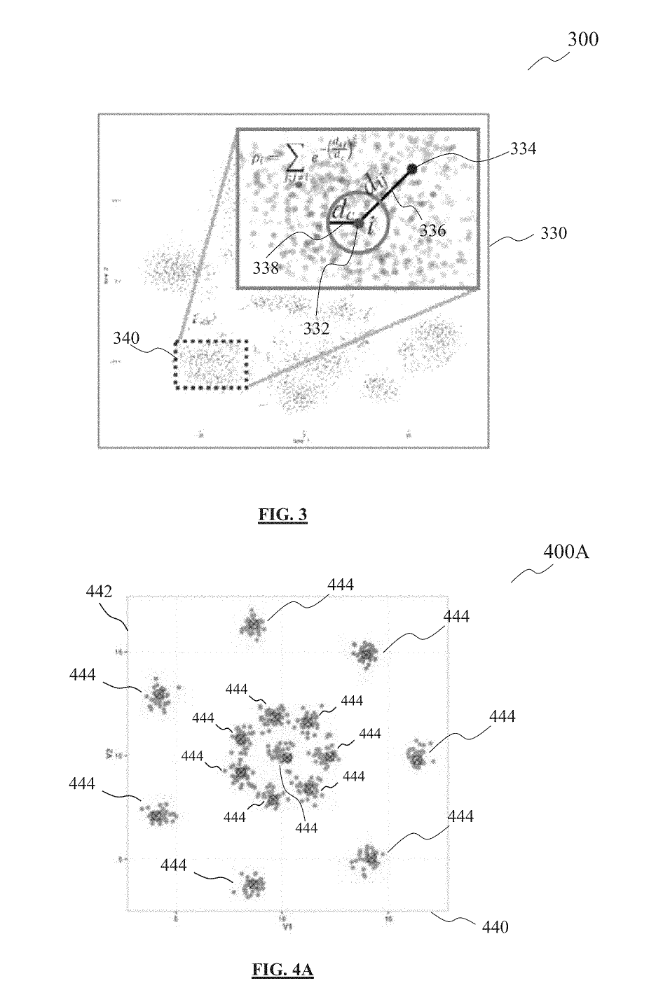

FIG. 3 shows an illustration 300 of the local density estimation process 202. A dataset 330 may include a large quantity of data points, and the dataset may include clusters of data points, such as cluster 340. The local density estimation process 202 may estimate the local density 112 of each data point in the dataset, using Equation (1). The local density 112 of the data point i 332 may be computed as the sum of exponential functions where the exponent depends on the distance between data point i 332 to all other data points. As an illustrative example, the distance between data point i 332 to another data point j 334 is shown as dᵢⱼ 336. The exponent may also depend on the cut-off distance d_{c} 338.

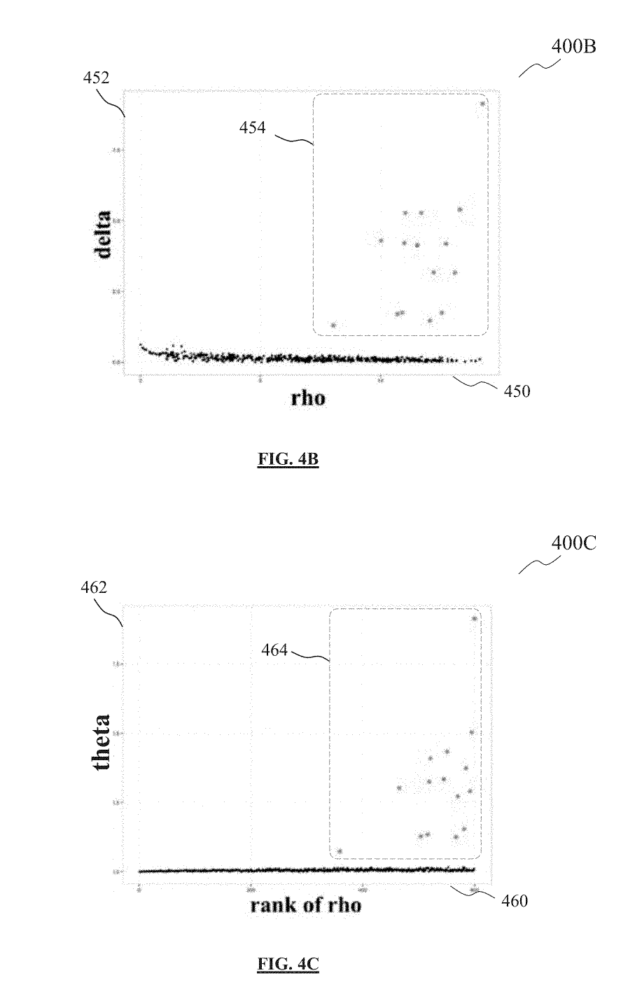

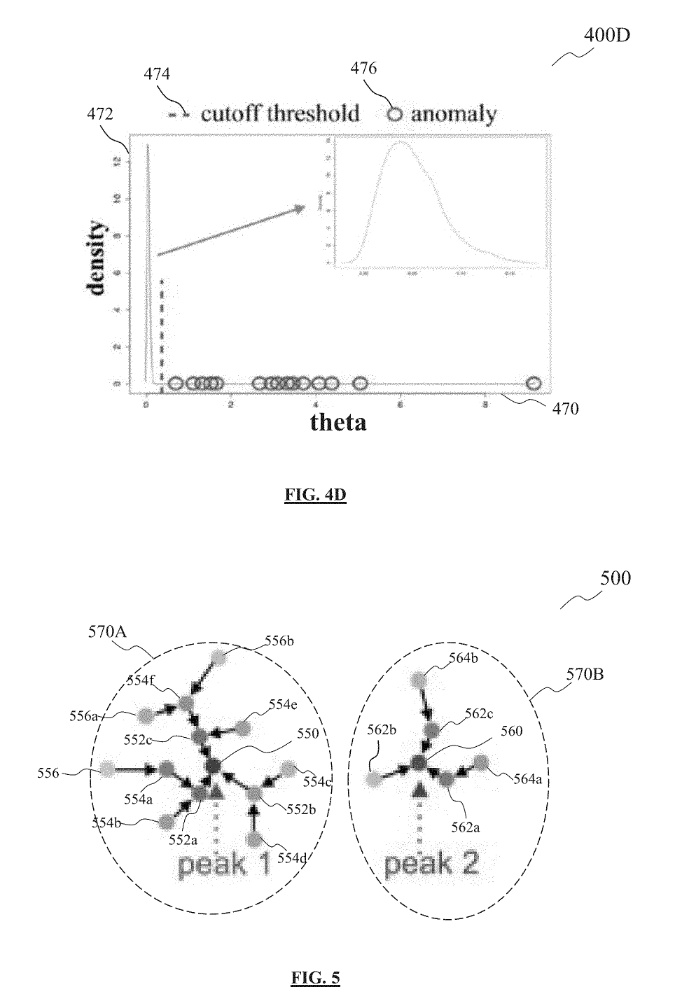

FIG. 4A-4D shows a series of graphs relating to the peak detection process 204. FIG. 4A shows a visual plot 400A of an example dataset. The visual plot 400A includes a horizontal axis 440 denoting a first dimension and a vertical axis 442 denoting a second dimension. The first dimension and the second dimension may be the dimensions of a t-SNE map. The example dataset may include 15 clusters 444. The cluster centre of each cluster 444 is labeled with a marker that shows a cross in a circle.

FIG. 4B shows a graph 400B showing the first parameter δ plotted against the local density 112. The graph 400B includes a horizontal axis 450 indicating values of the local density 112, and a vertical axis 452 indicating values of the first parameter δ. The graph 400B shows a plurality of outlying plots 454, which have relatively high values of δ. The density peaks of the example dataset may be amongst the data points that correspond to the plurality of outlying plots 454.

FIG. 4C shows a graph 400C showing the second parameter θ plotted against the rank of local density 112. The graph 400C includes a horizontal axis 460 indicating rank of the local density 112, and a vertical axis 462 indicating values of the second parameter. The graph 400C shows a plurality of outlying plots 464, which have relatively high values of θ. The density peaks of the example dataset may be amongst the data points that correspond to the plurality of outlying plots 464.

FIG. 4D shows a graph 400D showing the local density 112 plotted against the second parameter θ. The graph 400D includes a horizontal axis 470 indicating the second parameter, and a vertical axis 472 indicating the local density 112. A statistical test, such as the generalised ESD may be applied to automatically identify anomalies 476 in the second parameter, as well as anomalies in the local density 112. The statistical test may identify anomalies, by assuming that the second parameter follows a normal distribution. By applying the statistical test, the anomalies 476 may be identified without having to manually specify a cutoff. Instead, clusterX may automatically determine the cutoff threshold 474. In contrast, conventional clustering algorithm requires manually deciding on a cutoff threshold, or manually selecting the anomalies, which may lead to inaccuracies, since such decisions or selections may be subjective and may depend on the experience and skill level of the individual.

FIG. 5 shows an illustration 500 of the cluster assignment process 228. In a non-limiting example, the dataset may include a first density peak 550 and a second density peak 560. The first density peak 550 and the second density peak 560 may be data points identified as density peaks in the peak detection process 204. The first density peak 550 may be designated as the centre of a first cluster 570A. The second density peak 560 may be designated as the centre of a second cluster 570B. In this manner, a centre of the first cluster 570A and the centre of the second cluster 570B may be identified more efficiently and accurately than the above-mentioned conventional techniques. As a result, subjectivity intrinsic within the conventional approaches may be further decreased. The remaining data points in the dataset may be assigned to either the first cluster 570A or the second cluster 570B, according to Equation (4). The data points 552a-c, may be assigned to the first cluster 570A, as their nearest neighbor having higher local density may be the first density peak 550. The same assignment process may be applied to data points 554a-b. For each of data point 554a and data point 554b, the nearest neighbor having higher local density may be the data point 552a. Since data point 552a belongs to the first cluster 570A, data points 554a-b may also be assigned to the first cluster 570A. Similarly, data points 554c-d may be assigned to the first cluster 570A, since their nearest neighbor of higher local density is data point 552b which belongs to the first cluster 570A. Data points 554e-f may also be assigned to the same cluster as their nearest neighbor of higher local density, data point 552c. Data points 556a-b may also be assigned to the first cluster 570A, by virtue of data point 554f being their nearest neighbor of higher local density. Similarly, data points 562a-c may be assigned to the second cluster 570B, as the second density peak 560 may be their nearest neighbor with a higher local density. Data point 564a may be assigned to the second cluster 570B as well, because data point 562a is its nearest neighbor with a higher local density. Data point 564b may be assigned to the second cluster 570B, because data point 564c is its nearest neighbor with a higher local density. As an example, the local density of the first density peak 550 may be higher than the local density of the second density peak 560. However, data points 562a-c may still be assigned to the second cluster 570B, because the second density peak 560 is nearer to the data points 562a-c. The assignment process may be repeated until all data points in the dataset are assigned to a cluster. Each data point may represent a cell that is being characterized, such that each cluster may indicate a sub-population of the cells. Accordingly, the above-noted data points may be assigned to a respective cluster more efficiently and accurately than the above-mentioned conventional techniques. As a result, subjectivity intrinsic within the conventional approaches may be further decreased

According to various embodiments, the method for identifying clusters in a dataset may be applied on large datasets, such as the vast amount of data collected in mass cytometry. One basic calculation required for the method is the cell-cell, in other words, data point-to-data point distance dᵢⱼ. Computing the values of dᵢⱼ for the vast amount of data may pose a large load on computing memory. For example, for mass cytometry performed on millions of cells, the size of the dataset or the dissimilarity matrix obtained from the dimensionality reduction process 220, may run into 10 gigabits or more. Such a large size may have the potential to overload some personal computers. Provided this consideration, the method may include a split-apply-combine strategy. Instead of taking the entire dataset or entire dissimilarity matrix as an input, the data may be split into a plurality of smaller chunks so that the distance matrix calculated for each chunk may be of a smaller size.

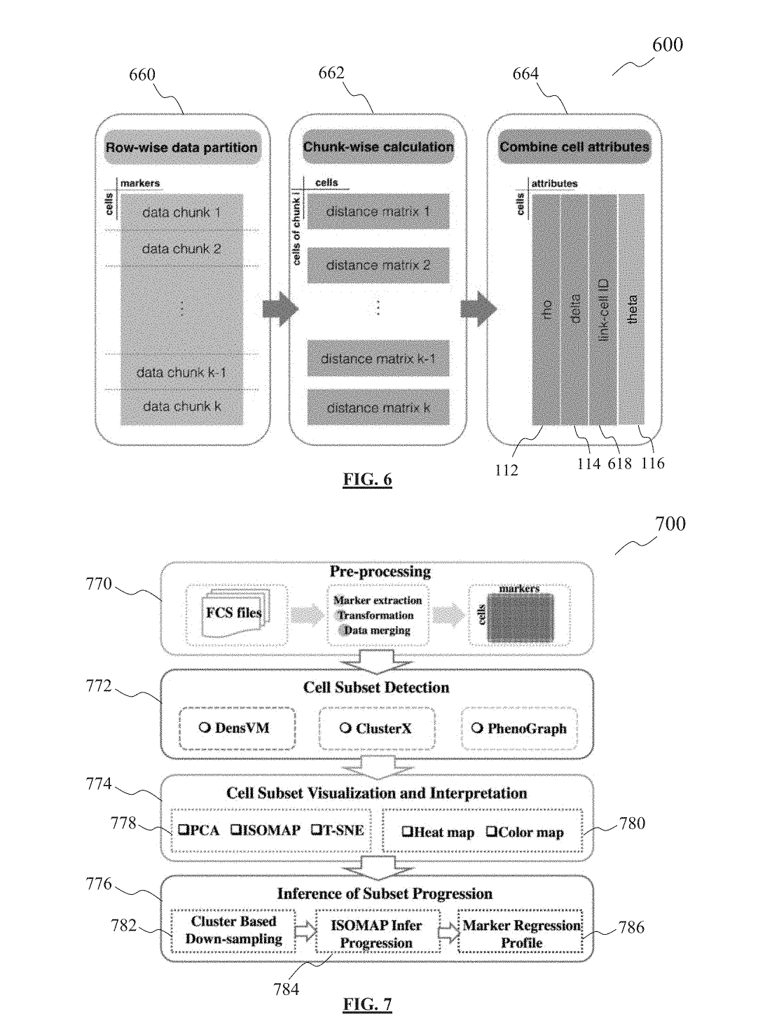

FIG. 6 shows a conceptual diagram 600 showing a method for identifying clusters in a dataset incorporating the split-apply-combine process, according to various embodiments. The method may include a partition process 660. In the partition process 660, the data in the dataset may be split row-wisely. Alternatively, the data may be split column-wisely or by other means. After portioning the data into chunks, each chunk of data may undergo the dimensionality reduction process 220 to generate a respective dissimilarity matrix. The method may further include a chunk-wise calculation process 662. In the chunk-wise calculation process 662, the distance matrix may be computed for each chunk, based on their respective dissimilarity matrix. The local density computation process 102, the delta computation process 104 and the theta computation process 106 may also be performed in each chunk. The computations in each chunk may be carried out separately from the computations in other chunks, either in parallel or sequentially. The chunk-wise calculation process 662 may further include computing a new parameter, referred herein as link-cell identity, in each chunk. The link-cell identity for each data point may be the identity of the nearest neighboring data point that has higher local density. Recording the link-cell identity in this process may eliminate the need for duplicate calculations in the cluster assignment process 228. The method may further include a combine process 664. In the combine process 664, the parameters computed in the chunk-wise calculation process 662 for each chunk may be combined back into a single dataset. The parameters may include at least one of local density 112, delta 114, theta 116 and the link-cell identity 618. The peak detection process 204 and the cluster assignment process 228 may be carried out using the combined data obtained from the combine process 664. By adopting the split-apply-combine strategy, the method may handle vast amount of data. In addition, the processing within separate chunks may be carried out in parallel to speed up the process of identifying clusters.

According to various embodiments, a method of analyzing cytometry data with the aid of a computer may be provided. The method may include providing the computer with a dataset including the cytometry data, and inputting the cytometry data to an analysis pipeline running on the computer. The analysis pipeline may be developed for running on data analysis software, or more specifically, genomic data analysis software for example, Bioconductor. The analysis pipeline may be developed in a statistical computing language and software environment, for example R. The analysis pipeline may identify clusters in the cytometry data, using the method of identifying clusters in a dataset according to various embodiments. The analysis pipeline may implement at least one process from the method 100 or the method 200.

FIG. 7 shows a schematic view of an analysis pipeline 700 according to various embodiments. The analysis pipeline 700 may include four major components, namely a pre-processing module 770, a subset detection module 772, a visualization and interpretation module 774 and an inference of subset progression module 776. The pre-processing module 770 may be configured to obtain a dataset from one or more input data files storing cytometry data. The input data files may be for example, in the form of flow cytometry standard (FCS) files. The pre-processing module 770 may extract expression values of a user-selected marker from each input data file and then apply an optimized logical transformation on the expression values to obtain an expression matrix from each input data file. The pre-processing module 770 may also scale the expression values in the expression matrix. The pre-processing module 770 may then merge the expression matrices of each input data file into a single matrix. The user of the analysis pipeline may customize the data merging strategy. The data merging strategies may include any one of “ceil” strategy, “all” strategy, “min” strategy or “fixed” strategy. The “ceil” strategy samples up to a user specified number of cells without replacement from each input data file. The “all” strategy takes all cell from each input data file. The “min” strategy samples the minimum number of cells among all the selected input data files from each input data file. The “fixed” strategy samples a user specified number of cells, with replacement when the total number of cell in the file is less than the specified number, from each input data file. The pre-processing module 770 may also preserve the file origin of the cells using unique cell names. The cell names may include concatenations of the file name and its sequence identity in the file.

The subset detection module 772 may include a clustering algorithm. The clustering algorithm may implement a method of identifying clusters in a dataset according to various embodiments. The clustering algorithm for implementing the method may be referred herein as ClusterX. In other words, ClusterX may embody the method of identifying clusters. The method may include at least one process from the method 200 or the method 1500 described in subsequent paragraphs. As an illustrative example, in addition to ClusterX, the subset detection module 772 may also include state-of-the-art clustering algorithms such as Density-based clustering aided by support Vector Machine (DensVM) and PhenoGraph. DensVM may first perform a preliminary clustering that inevitably leaves a significant number of cells unassigned to any clusters, then assign the unassigned cells to clusters with the assistance of a trained classifier that matches the patterns of marker expression profiles of the unassigned cells to the marker expressions profiles of the clusters from the preliminary clustering. DensVM may be computationally intensive, and thus may require large computations resources or a long time to identify clusters accurately. PhenoGraph is a graph-based partitioning method that works directly on the high-dimensional cytometry data. PhenoGraph may first construct a nearest-neighbor graph which captures the phenotypic relatedness of the high-dimensional data, and then applies a graph partition algorithm to dissect the nearest-neighbor graph into phenotypically coherent subpopulations.

The visualization and interpretation module 774 may include a dimensionality reduction sub-module 778 and a map sub-module 780. The dimensionality reduction sub-module 778 may transform the high-dimensional cytometry dataset to a low-dimensional representation, and may thereby allow visualization of the cells in a single plot. The low-dimensional representation may be a two-dimensional map. The dimensionality reduction sub-module 778 may employ any dimensionality reduction method, for example a linear transformation such as Principal Component Analysis (PCA), or a nonlinear transformation such as ISOMAP or t-SNE. Each method may provide specific utility for certain use cases. In some aspects, the t-SNE method may be able to capture nonlinear relationships. The t-SNE may embed data from high dimensional space into the lower dimensional map based on similarities. On a t-SNE map, similar cells may be placed in vicinity, while dissimilar cells may be placed far apart. The t-SNE method may be able to visualize phenotypic relationships between cells, such as normal and leukemic bone marrow cells. The map sub-module 780 may receive the two-dimensional map from the dimensionality reduction sub-module 778, to plot the two-dimensional map as one of a heat map or a color map. In the color map, each cluster identified by the subset detection module 772 may be represented with a different color. Each cluster may represent one cell type. The color map may also display different shapes for points on the map belong to different input data files, so as to indicate which sample the cells belong to. The heat map may visualize the median expression level for each marker in each cell type. The heat map may facilitate the interpretation of known cell types based on prior knowledge of their special marker expression features as well as detection of new cell types with novel expression patterns.

The inference of subset progression module 776 may profile the marker expression along the cell subset progression. In other words, the inference of subset progression module 776 may infer the cellular progression at the subset level. The inference of subset progression module 776 may include a down-sampling sub-module 782, an infer progression sub-module 784 and a marker regression profile sub-module 786. The down-sampling sub-module 782 may down-sample the number of cells in each cluster as identified by the cell subset detection module 772, to an equal size in order to remove the dominance effect of big populations. By removing the dominance effect of big populations, the small populations may be highlighted to maintain the phenotypical continuity of progression. The infer progression sub-module 784 may run ISOMAP on the down-sampled dataset from the down-sampling sub-module 782 and overlay the clusters onto the first two ISOMAP dimensions. The ISOMAP may be suitable for mapping cellular progression as ISOMAP takes into account of local distances for similar cells while retaining the global geometry between different cell types. Alternatively, the ISOMAP may be replaced by other methods of dimensionality reduction. The marker regression profile sub-module 786 may draw and annotate hypothesized paths of subset progression by checking the median position of clusters in the ISOMAP. Instead of directly estimating the cell developmental path from the data which may be computationally comprehensive and error prone, the inference of subset progression module 776 may provide an assistant approach for inferring the progression based on the relationship of cell subsets and subjective speculation.

According to various embodiments, a software package including the analysis pipeline 700 may be provided. The software package may be a comprehensive toolset or portion thereof for mass cytometry data analysis. The software package may be configured to carry out the method of analyzing cytometry data according to various embodiments. The software package may also include functions for data pre-processing, data visualization through linear or non-linear dimensionality reduction, automatic identification of cell subsets, and inferring the relatedness between cell subsets. The software package may include a Graphical User Interface (GUI). The software package may also be provided as a web application. The software package may be developed with a general framework, which makes it extensible to add in new methods and also applicable to other multi-parameter data types.

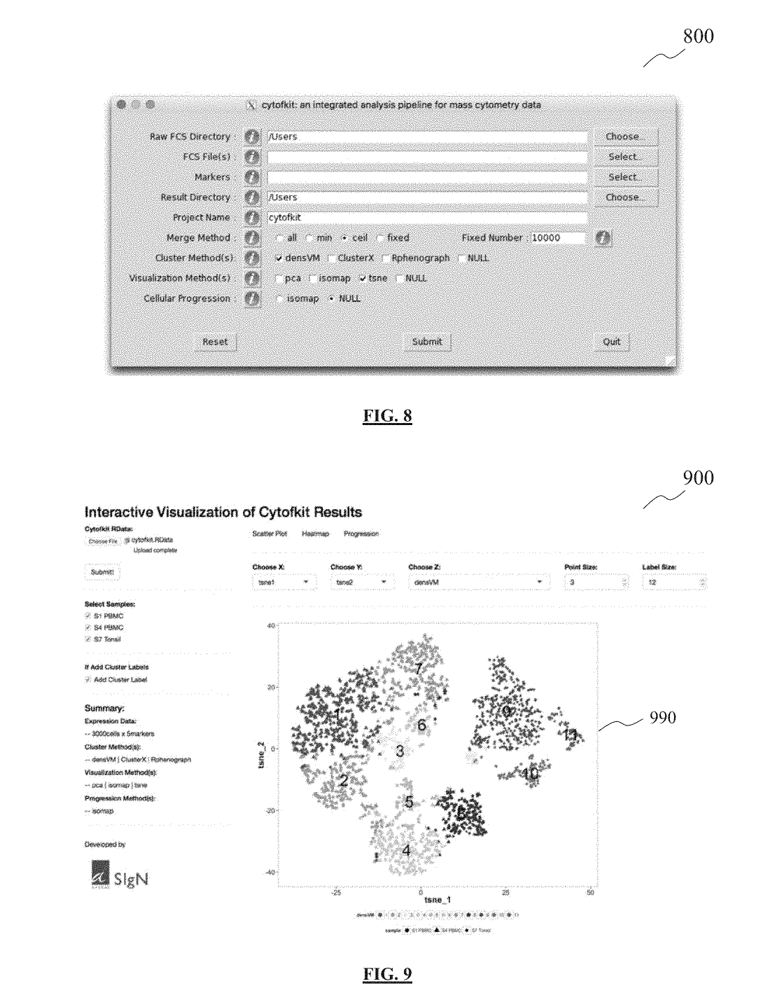

FIG. 8 shows an example of the GUI 800 of the software package according to various embodiments. In some aspects, the GUI may allow a user to customize his or her analysis without any coding knowledge. In other aspects, however, a user may adapt one or more features of the software package via machine and/or user input of executable code. The GUI may provide options for the user to choose the preferred merging method, cluster method and visualization method. The GUI may provide explanations with regard to each option.

FIG. 9 shows an example of the user interface of the web application 900 according to various embodiments. The data analysis pipeline 700 may save the analysis results as an RData object that may be loaded into the web application 900. The web application 900 may provide an interactive user interface. The web application 900 may be configured to generate an interactive visualization 990 of the analysis results, including the cell subpopulations and progression profiles of key markers. Users may use the web application 900 to easily explore the relationship of cell subsets, and to explore the expression patterns mapped on the ISOMAP dimension 1 and dimension 2 as well as check the expression regression profile of each marker on single ISOMAP dimension.

In the following, a demonstration of the method of analyzing cytometry data according to various embodiments will be described. The demonstration was carried out using one or more features of the software package described above. The method was demonstrated using two datasets. The first dataset is a CD14⁻CD19⁻ peripheral blood mononuclear (PBMCs) dataset and the second dataset is a CD4⁺T cell dataset combined from human blood and tonsils. In order to assess the accuracy of the software package, the populations of CD4⁺, CD8⁺, γδT, CD3⁺CD56⁺NKT and CD3⁻CD56⁺NK cells were manually gated from the CD14⁻CD19⁻ PBMCs dataset. The population of naïve cells (CD45RA⁺CCR7⁺CD45RO⁻), T_{H}1 (IFN-γ⁺), T_{H}17 (IL-17A⁺) and T_{FH} (CXCR5^{hi}PD-1^{hi}) were manually gated from the CD4+ T cell dataset. The dimensionality reduction methods PCA, ISOMAP and t-SNE were applied to the two datasets to assess their effectiveness.

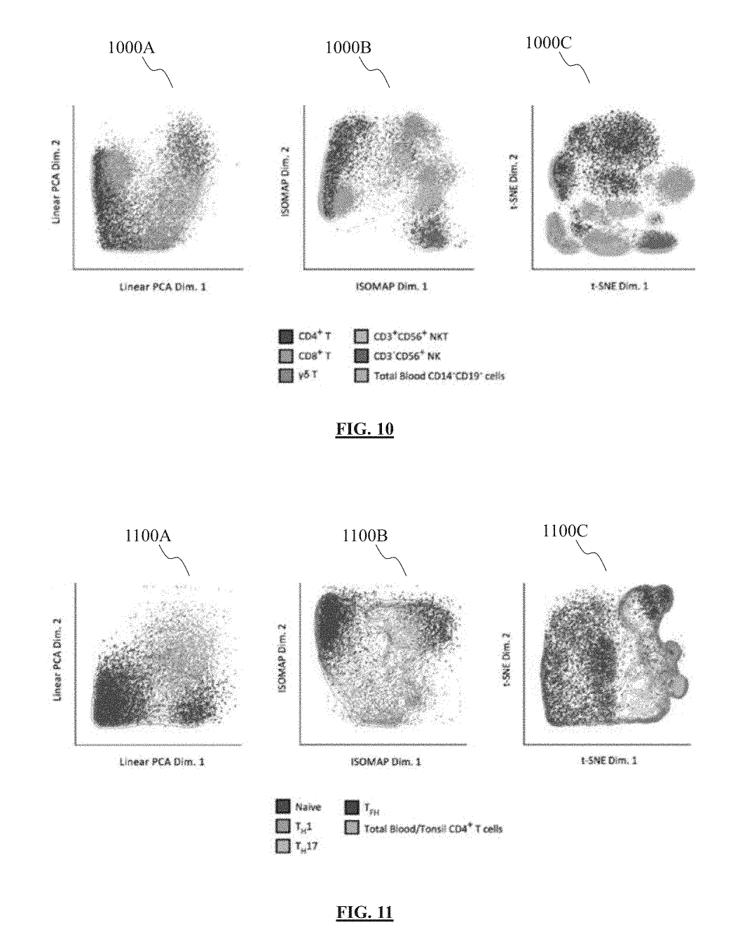

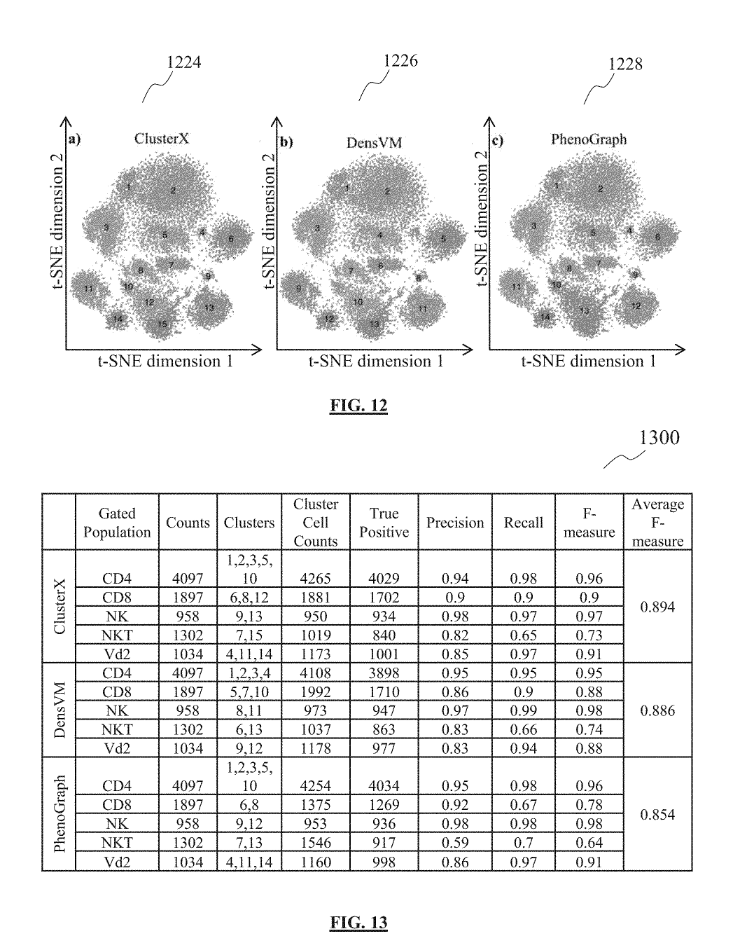

FIG. 10 shows a comparison of dimensionality reduction methods, as applied onto the first dataset. FIG. 10 includes a first chart 1000A, a second chart 1000B and a third chart 1000C. In each chart, cells were plotted using the first two dimensions of the dimensionality-transformed data color coded by gated populations. The first chart 1000A shows the plot obtained from applying PCA. The second chart 1000B shows the plot obtained from applying ISOMAP. The third chart 1000C shows the plot obtained from applying t-SNE. The gated lymphocyte and NK cell populations were overlaid onto the plots of the three dimensionality reduction methods. The first chart 1000A displays a continuous U-shaped pattern of cellular clusters. The second chart 1000B preserved the U-shaped continuum while showing better resolution of CD4⁺, CD8⁺, γδT, CD3⁺CD56⁺NKT and CD3⁻CD56⁺NK cells. In contrast, the third chart 1000C showed geometrically distinct clusters at much higher resolution and discriminated several populations within the CD4⁺T cell population. The third chart 1000C did not display the continuum as seen in the second chart 1000B.

FIG. 11 shows a comparison of dimensionality reduction methods, as applied onto the second dataset. FIG. 11 includes a first chart 1100A, a second chart 1100B and a third chart 1100C. In each chart, cells were plotted using the first two dimensions of the dimensionality-transformed data color coded by gated populations. The first chart 1100A shows the plot obtained from applying PCA. The second chart 1100B shows the plot obtained from applying ISOMAP. The third chart 1100C shows the plot obtained from applying t-SNE. The naïve (CD45RA⁺CCR7⁺CD45RO⁻), T_{H}1 (IFN-γ⁺), T_{H}17 (IL-17A⁺) and T_{FH} (CXCR5^{hi}PD-1^{hi}) cells were overlaid onto the dimensionality-reduced maps. The second chart 1100B and the third chart 1100C shows that each subset occupied distinct regions, whereas the first chart 1100A shows that the T_{H}1 and T_{H}17 cells overlapped in the same region.

The comparisons shown in FIGS. 10 and 11 highlighted some improvements of non-linear dimensionality reduction approaches over a linear dimensionality reduction approach for visualizing and interpreting mass cytometry data. Although t-SNE better discriminated cells of distinct phenotypes, t-SNE's topology may be limited in certain use cases. For example, while t-SNE may be able to identify clusters of cells, it places the clusters at arbitrary locations such that the relative locations of the clusters may not be useable for inferring the relationship between the clusters. t-SNE may not consistently reproduce the same global geometry of the clusters, in other words, the global topology of t-SNE may not be consistent between different runs of the analysis. For example, the distance between two clusters may be small in a first run of the analysis, while the distance between the same two clusters may be large in a second run of the analysis. In some aspects, t-SNE may be used in conjunction with ISOMAP for interpreting relatedness between subsets.

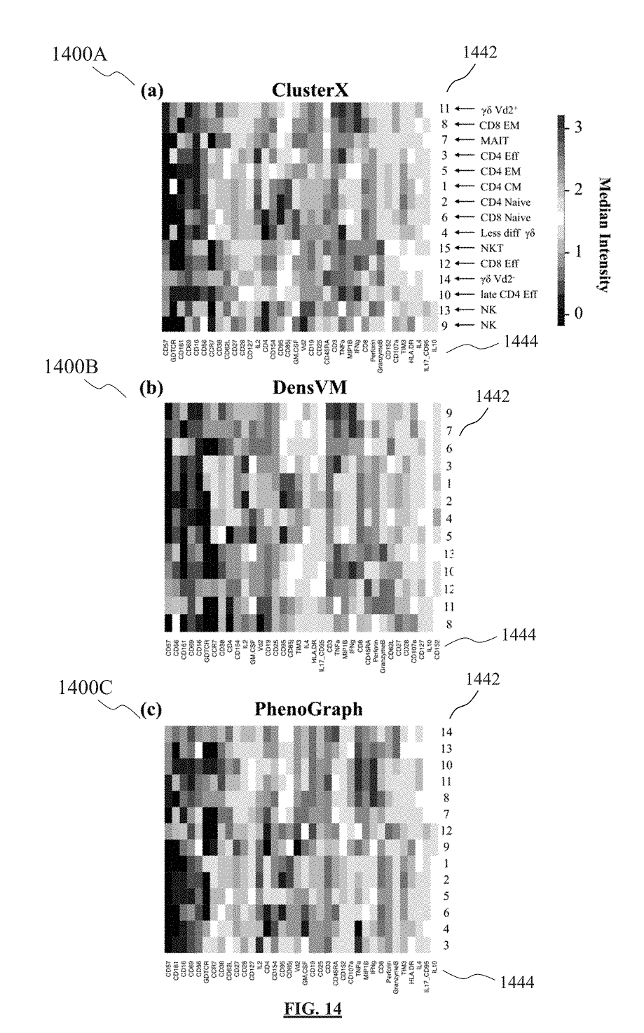

FIG. 12 shows a comparison of clustering performed by various clustering algorithms. The clustering algorithms may be used in the subset detection module 772. FIG. 12 shows three maps, 1224, 1226 and 1228. Each map shows the clustering results from a respective clustering algorithm mapped on the t-SNE plot. Each map includes a horizontal axis indicating the first dimension, and a vertical axis indicating the second dimension. The clusters are indicated with their respective cluster IDs on the maps. The first map 1224 shows the clustering results from the ClusterX algorithm. The ClusterX algorithm, when executed on a computer, may cause the computer to perform a series of processes including at least one of the method 100 or the method 200. The first map 1225 shows 15 clusters. The second map 1226 shows the clustering results from DensVM. The second map 1226 shows 13 clusters. The third map 1228 shows the clustering results from PhenoGraph. The third map 1228 shows 14 clusters. These clusters were manually mapped to the gated populations using FlowJo. To assess the performance of these clustering methods, the precision, recall and F-measure of each clustering method were quantitatively calculated, using manually gated populations of CD4⁺, CD8⁺, γδT, NK and NKT cells from the CD14−CD19− PBMCs dataset.

FIG. 13 shows a table 1300 showing the cluster results as compared to the manually gated population of the first dataset. The table 1300 shows that ClusterX produced a higher average precision score as compared to DensVM and PhenoGraph. The F-measures for DensVM, ClusterX and PhenoGraph are 0.886, 0.894 and 0.854 respectively, which shows that all these three clustering methods may accurately identify the gated cellular populations. In the first dataset, i.e. the CD14⁻CD19⁻ PBMCs dataset, ClusterX identified 15 unique clusters which is the highest number of clusters among all three cluster results.

FIG. 14 shows the heatmaps of the median marker expression of clusters detected by ClusterX, DensVM and PhenoGraph. The heatmap row labels 1442 represent the cluster IDs and the column labels 1444 show the marker names. The clusters are annotated by its expression profile. Heatmap 1400A is the heatmap of the 15 clusters identified by ClusterX. The heatmap 1400A shows different stages of CD4⁺ and CD8⁺T cell differentiation, and three subsets of γδT, NK and NKT cells. Heatmap 1400B is the heatmap of the 13 clusters identified by DensVM. DensVM is unable to identify the less differentiated γδ population and late CD4 effective memory population. Heatmap 1400C is the heatmap of the 14 clusters identified by PhenoGraph. PhenoGraph mixed the CD8 effective memory population with the NKT population. All three clustering methods showed great capacity in defining the cellular heterogeneity with much higher efficiency and resolution compared to manual gating, though ClusterX was the only method that identified all 15 clusters.

As shown in the demonstration results, ClusterX, when applied to the first dataset (CD14⁻CD19⁻ PBMC dataset), was not only able to accurately detect and identify known cellular populations of lymphocytes including CD4⁺, CD8⁺, γδT, NK, and NKT cells, but was also able to segregate these subsets further to reveal novel subpopulations such as different stages of CD4⁺ and CD8⁺T cell differentiation, as well as three subsets of γδT and two subsets of NK cells. Moreover, in a separate demonstration applying ClusterX on the second dataset (human CD4+ T cell dataset) derived from peripheral blood versus tonsils, ClusterX detected three hypothesized progression paths spanning across blood and tonsils derived from naïve T cells and uncovered multiple subtypes of follicular helper T cells (T_{FH}) cells that followed a continuum spanning both blood and tonsils. The interference of subset progression module 776 also revealed the phenotypic progression of T_{H}1 and T_{FH} cells across blood and tonsils. Therefore, the demonstrations showed that ClusterX is not only able to accurately detect and identify known cellular populations; it is also able to segregate these subsets further to reveal novel subpopulations. In addition, the interference of subset progression module 776 may further estimate the subset progression after receiving the identified clusters from the subset detection module 772.

According to various embodiments, a method of analyzing cytometry data may be provided. The method may be embodied in a software package including an integrated analysis pipeline. The integrated analysis pipeline may provide a one-stop analysis toolkit for mass cytometry data with user-selectable options and a customizable framework. The software package may perform data analysis including pre-processing, cell subset detection, plots for visualization and annotation, and inference of the relatedness between cell subsets. The software package may present the analysis results in an interactive way using a specifically designed web application. The software package may provide an automated method of analyzing mass cytometry data, such that even bench scientists without cytometry data analysis training may obtain the analysis results. The method of analyzing cytometry data includes a method for identifying clusters, referred herein as ClusterX. The method may include detecting density peaks, or cluster centers automatically. In some aspects, input of an arbitrary threshold is not provided manually. In other aspects, input of an arbitrary threshold is received manually. For instant, manual input of an arbitrary threshold may be compared, correlated, and/or averaged, etc. with the automatically detected peaks or clusters. The method may also reduce the computational load of analyzing the cytometry data in each computer, by applying a split-apply-combine strategy. The method may also include a dimensionality reduction process, to handle the computational resources' capacity of clustering for high-dimensional data.

FIG. 15 shows a flow diagram of a method 1500 for identifying clusters in a dataset, according to various embodiments. The method 1500 may be part of the method 200, or may include the method 200. The method 1500 may include processes 1550, 1552 and 1554. Process 1550 may include determining for each data point in the dataset, a plurality of parameters including a first parameter and a second parameter. The process 1550 may include the method 100. For each data point, the first parameter may be a distance between the data point and a nearest other data point having a local density that is higher than a local density of the data point; while the second parameter may be a function of the local density of the data point and the first parameter. The first parameter may also be referred herein as delta or δ. The local density of the data point may include a summation of a plurality of distance variables, each distance variable of the plurality of distance variables indicative of a distance between the data point and a respective other data point in the dataset. The distance variables may be arranged in a distance matrix. Each distance variable may include an exponential function, wherein an exponent of the exponential function includes a function of the distance between the data point and the respective other data point in the dataset. The second parameter may also be referred herein as theta or θ. The process 1550 may include multiplying the first parameter and the local density. The second parameter may be the product of the first parameter and the local density. Process 1552 may include running statistical tests on each of the first parameter and the second parameter across the dataset, to identify outliers of the first parameter and outliers of the second parameter. The statistical test may include a generalized ESD test. Process 1554 may include designating each data point where both the first parameter and the second parameter are identified outliers, as a centre of a respective cluster. The method may 1500 may further include assigning each data point that is not one of the centers of clusters, to the cluster of the nearest other data point having the local density that is higher than the local density of the data point.

According to various embodiments, the process 1550 may include applying a dimensionality reduction algorithm on the dataset, to generate a reduced dimensionality dataset. This process may be identical to, or at least substantially similar to, the dimensionality reduction process 220. The dimensionality reduction algorithm may be a non-linear dimensionality reduction algorithm, for example, t-distributed stochastic neighbor embedding algorithm (t-SNE). The process 1550 may further include determining the plurality of parameters based on the reduced dimensionality dataset.

According to various embodiments, the process 1550 may include dividing the dataset into a plurality of sub-sections. This process may be identical to, or at least substantially similar to the partition process 660. The process 1550 may further include computing for each sub-section, the plurality of parameters of each data point in the sub-section. This process may be identical to, or at least substantially similar to the chunk-wise calculation process 662. The computations for the plurality of sub-sections may be performed in parallel. The process 1550 may further include applying a dimensionality reduction algorithm on each sub-section of the plurality of sub-sections to generate a respective reduced dimensionality dataset. Computing for each sub-section may include computing the plurality of parameters of each data point in the sub-section, based on the respective reduced dimensionality dataset. The process 1550 may further include determining for each sub-section, a third parameter of each data point in the sub-section, wherein the third parameter is an identity of a nearest other data point within the sub-section, having a local density that is higher than the local density of the data point. The third parameter may be the link-cell ID shown in FIG. 6. The process 1550 may further include combining the computed plurality of parameters from the plurality of sub-sections, into a single matrix. This process may be identical to, or at least substantially similar to the combine process 664. The process 1550 may further include running statistical tests on each of the first parameter and the second parameter on the single matrix.

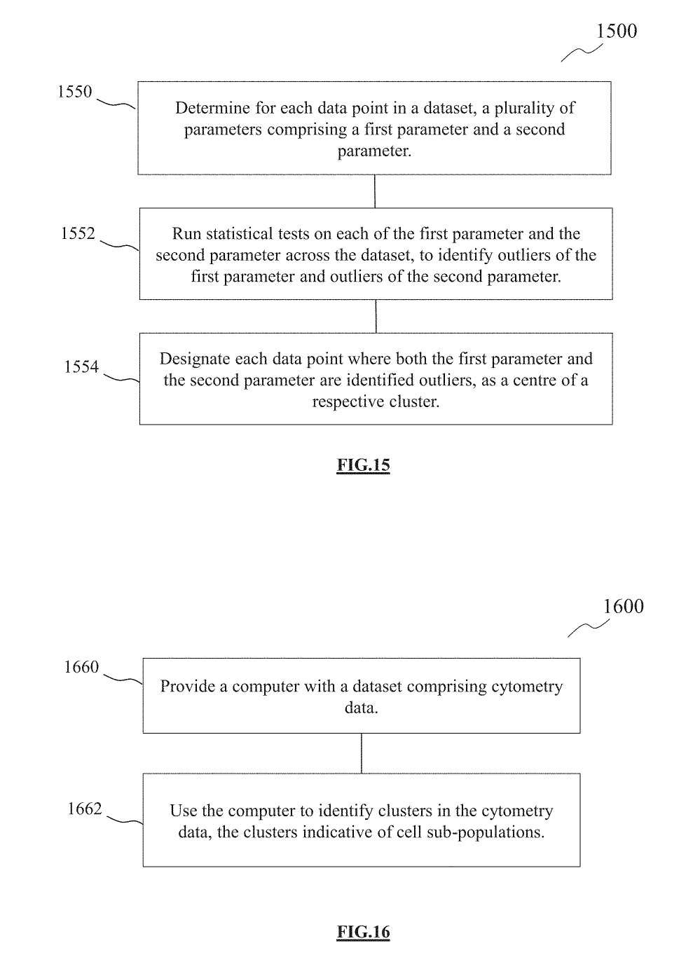

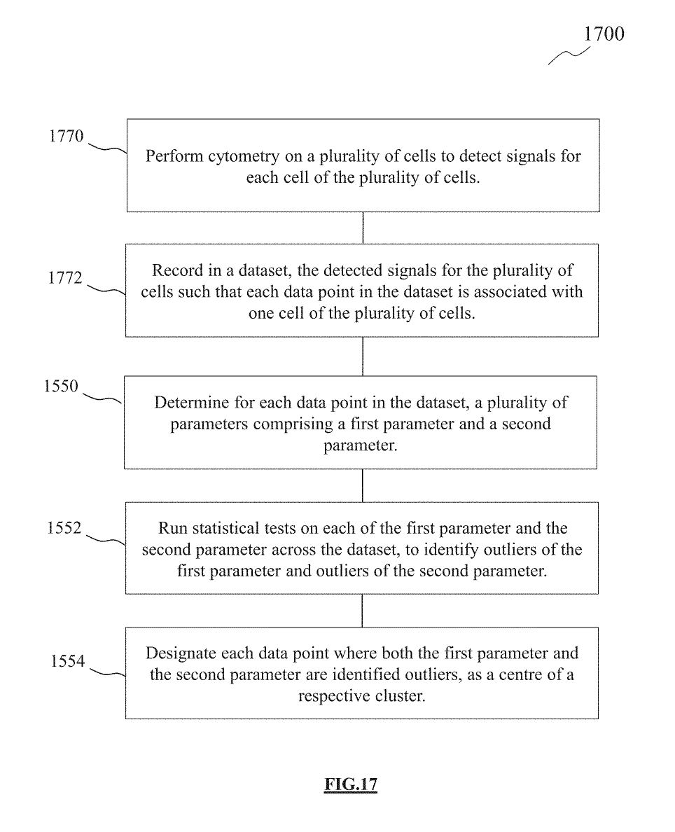

FIG. 16 shows a flow diagram of a method 1600 of analyzing cytometry data with the aid of a computer, according to various embodiments. The method 1600 may be part of the method 200, or may include the method 200. The method 1600 may include processes 1660 and 1662. Process 1660 may include providing the computer with a dataset including the cytometry data. Process 1662 may include using the computer to identify clusters in the cytometry data. The clusters may be indicative of cell sub-populations. Process 1662 may include the method 1500.

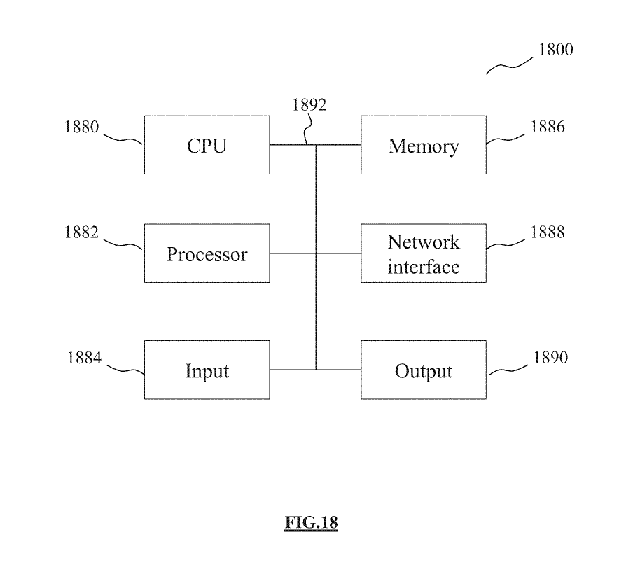

FIG. 17 shows a flow diagram of a method 1700 of detecting cell sub-populations in a plurality of cells, according to various embodiments. The method 1700 may include the method 1600. The method 1700 may include processes 1770 and 1772, followed by processes 1550, 1552 and 1554 of the method 1500. Process 1770 may include performing cytometry on the plurality of cells to detect signals for each cell of the plurality of cells. Process 1772 may include recording in a dataset, the detected signals for the plurality of cells such that each data point in the dataset is associated with one cell of the plurality of cells.

According to various embodiments, a non-transitory computer readable medium may be provided. The non-transitory computer readable medium may include instructions which, when executed by a computer, may cause the computer to perform the method 1500.

FIG. 18 shows a conceptual diagram of a computer system 1800 configured to perform the method 1500, or may be used to facilitate the methods 1600 or 1700, according to various embodiments. The computer system 1800 may include a central processing unit (CPU) 1880, a processor 1882, a memory 1886, a network interface 1888, an input interface 1884 and an output interface 1890. All the components 1880, 1882, 1886, 1888, 1884 and 1890 of the computer system 1800 may be connected or coupled for communicating with each other through a computer bus 1892. The memory 1886 may include a non-transitory computer readable medium which may include instructions that when executed by the CPU 1880 or the processor 1882, causes the CPU 1880 or the processor 1882 to perform the method 1500. The memory 1886 may include more than one memory, such as RAM, ROM, EPROM, hard disk, etc. wherein some of the memories are used for storing data and programs and other memories are used as working memories. The memory 1886 may store the dataset that is to be analyzed, or used for identification of clusters. The memory 1886 may also store the analysis pipeline 700. The memory 1886 may store the pre-processing module 770, the subset detection module 772, the visualization and interpretation module 774 and the inference of subset progression module 776.

According to various embodiments, the various processes described herein, including the density computation process 102, the delta computation process 104, the theta computation process 106, the dimensionality reduction process 220, the local density estimation process 202, the peak detection process 204, the cluster assignment process 228, the partition process 660, the chunk-wise calculation process 662 and the combine process 664 may be implemented as modules that are executable on one or more computer systems 1800. Any one of the processes 1550, 1552, 1554, 1662 or 1772 may also be implemented as modules that are executable on one or more computer systems 1800.

According to various embodiments, the processor 1882 may be a special purpose processor, in this example, a cluster identifier for executing the method 1500.

The CPU 1880 or the processor 1882 may be connected to an internal network (e.g. a local area network (LAN) or a wide area network (WAN) within an organization) and/or an external network (e.g. the Internet) through the network interface 1888. The CPU 1880 or the processor 1882 may provide data to the web application 900 through the network interface 1888. The input 1884 may include a connection to a cytometry equipment, and may also include connections to a mouse, a keyboard, or a data cable. The input 1884 may receive the dataset, or the cytometry data. The output 1890 may transmit the clustered dataset, or information of the clusters, or visualization of the clusters. The output 1890 may include a display for display the visualization of the clusters, or display the GUI 800 of the software package.

The following examples pertain to further embodiments.

Example 1 is a method for identifying clusters in a dataset, the method including: determining for each data point in the dataset, a plurality of parameters including a first parameter and a second parameter, the first parameter being a distance between the data point and a nearest other data point having a local density that is higher than a local density of the data point, and the second parameter being a function of the local density of the data point and the first parameter; running statistical tests on each of the first parameter and the second parameter across the dataset, to identify outliers of the first parameter and outliers of the second parameter; and designating each data point where both the first parameter and the second parameter are identified outliers, as a centre of a respective cluster.

Example 2 is a non-transitory computer-readable medium including instructions which, when executed by a computer, causes the computer to perform a method for identifying clusters in a dataset, the method including: determining for each data point in the dataset, a plurality of parameters including a first parameter and a second parameter, the first parameter being a distance between the data point and a nearest other data point having a local density that is higher than a local density of the data point, and the second parameter being a function of the local density of the data point and the first parameter; running statistical tests on each of the first parameter and the second parameter across the dataset, to identify outliers of the first parameter and outliers of the second parameter; and designating each data point where both the first parameter and the second parameter are identified outliers, as a centre of a respective cluster.

Example 3 is a method of analyzing cytometry data with the aid of a computer, the method including: providing the computer with a dataset including the cytometry data; using the computer to identify clusters in the cytometry data, the clusters indicative of cell sub-populations, wherein identifying the clusters includes: determining for each data point in the dataset, a plurality of parameters including a first parameter and a second parameter, the first parameter being a distance between the data point and a nearest other data point having a local density that is higher than a local density of the data point, and the second parameter being a function of the local density of the data point and the first parameter; running statistical tests on each of the first parameter and the second parameter across the dataset, to identify outliers of the first parameter and outliers of the second parameter; and designating each data point where both the first parameter and the second parameter are identified outliers, as a centre of a respective cluster.

Example 4 is a method of detecting cell sub-populations in a plurality of cells, the method including: performing cytometry on the plurality of cells to detect signals for each cell of the plurality of cells; recording in a dataset, the detected signals for the plurality of cells such that each data point in the dataset is associated with one cell of the plurality of cells; determining for each data point in the dataset, a plurality of parameters including a first parameter and a second parameter, the first parameter being a distance between the data point and a nearest other data point having a local density that is higher than a local density of the data point, and the second parameter being a function of the local density of the data point and the first parameter; running statistical tests on each of the first parameter and the second parameter across the dataset, to identify outliers of the first parameter and outliers of the second parameter; and designating each data point where both the first parameter and the second parameter are identified outliers, as a centre of a respective cluster, wherein each cluster is indicative of a cell sub-population.

In example 5, the subject-matter of any of examples 1 to 4 can optionally include that the second parameter includes a product of the first parameter and the local density of the data point.

In example 6, the subject-matter of any of examples 1 to 5 can optionally include that the statistical tests includes a generalized Extreme Studentized Deviate Test.

In example 7, the subject-matter of any of examples 1 to 6 can optionally include that the outliers of the first parameter are anomalously large as compared to other values of the first parameter of other data points.

In example 8, the subject-matter of any of examples 1 to 7 can optionally include that the outliers of the second parameter are anomalously large as compared to other values of the second parameter of other data points.

In example 9, the subject-matter of any of examples 1 to 8 can optionally include that determining the plurality of parameters for each data point includes: dividing the dataset into a plurality of sub-sections; and computing for each sub-section, the plurality of parameters of each data point in the sub-section.

In example 10, the subject-matter of example 9 can optionally include that determining the plurality of parameters for each data point further includes: applying a dimensionality reduction algorithm on each sub-section of the plurality of sub-sections to generate a respective reduced dimensionality dataset; wherein computing for each sub-section includes computing the plurality of parameters of each data point in the sub-section, based on the respective reduced dimensionality dataset.

In example 11, the subject-matter of examples 9 or 10 can optionally include that determining the plurality of parameters for each data point further includes: determining for each sub-section, a third parameter of each data point in the sub-section, wherein the third parameter is an identity of a nearest other data point within the sub-section, having a local density that is higher than the local density of the data point.

In example 12, the subject-matter of any one of examples 9 to 11 can optionally include combining the computed plurality of parameters from the plurality of sub-sections, into a single matrix.

In example 13, the subject-matter of example 12 can optionally include that running the statistical tests on each of the first parameter and the second parameter includes running the statistical tests on the single matrix.

In example 14, the subject-matter of any one of examples 9 to 13 can optionally include that the computations for the plurality of sub-sections are performed in parallel.

In example 15, the subject-matter of any of examples 1 to 14 can optionally include that the local density of the data point includes a summation of a plurality of distance variables, each distance variable of the plurality of distance variables indicative of a distance between the data point and a respective other data point in the dataset.

In example 16, the subject-matter of example 15 can optionally include that each distance variable includes an exponential function, wherein an exponent of the exponential function includes a function of the distance between the data point and the respective other data point in the dataset.

In example 17, the subject-matter of any of examples 1 to 16 can optionally include that determining the plurality of parameters of each data point in the dataset includes applying a dimensionality reduction algorithm on the dataset, to generate a reduced dimensionality dataset.

In example 18, the subject-matter of example 17 can optionally include that determining the plurality of parameters of each data point in the dataset further includes determining the plurality of parameters based on the reduced dimensionality dataset.

In example 19, the subject-matter of example 17 or 18 can optionally include that the dimensionality reduction algorithm is a non-linear dimensionality reduction algorithm.

In example 20, the subject-matter of example 19 can optionally include that the dimensionality reduction algorithm is t-distributed stochastic neighbor embedding algorithm.

In example 21, the subject-matter of any of examples 1 to 20 can optionally include that the dataset includes mass cytometry data.

In example 22, the subject-matter of any of examples 1 to 21 can optionally include that the centre of each cluster corresponds to a density peak in the dataset.

In example 23, the subject-matter of any of examples 1 to 22 can optionally include for each data point that is not one of the centers of clusters: assigning the data point to the cluster of the nearest other data point having the local density that is higher than the local density of the data point.

While the foregoing has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

1. A method for identifying clusters in a dataset, the method comprising:
determining for each data point in the dataset, a plurality of parameters comprising a first parameter and a second parameter,
the first parameter being a distance between the data point and a nearest other data point having a local density that is higher than a local density of the data point, and
the second parameter being a function of the local density of the data point and the first parameter;
running statistical tests on each of the first parameter and the second parameter across the dataset, to identify outliers of the first parameter and outliers of the second parameter; and
designating each data point where both the first parameter and the second parameter are identified outliers, as a centre of a respective cluster.

2. The method of claim 1, wherein the second parameter comprises a product of the first parameter and the local density of the data point.

3. The method of claim 1, wherein the statistical tests comprises a generalized Extreme Studentized Deviate Test.

4. The method of claim 1, wherein the outliers of the first parameter are anomalously large as compared to other values of the first parameter of other data points.

5. The method of claim 1, wherein the outliers of the second parameter are anomalously large as compared to other values of the second parameter of other data points.

6. The method of claim 1, wherein determining the plurality of parameters for each data point comprises:
dividing the dataset into a plurality of sub-sections; and
computing for each sub-section, the plurality of parameters of each data point in the sub-section.

7. The method of claim 6, wherein determining the plurality of parameters for each data point further comprises:
applying a dimensionality reduction algorithm on each sub-section of the plurality of sub-sections to generate a respective reduced dimensionality dataset;
wherein computing for each sub-section comprises computing the plurality of parameters of each data point in the sub-section, based on the respective reduced dimensionality dataset.

8. The method of claim 6, wherein determining the plurality of parameters for each data point further comprises:
determining for each sub-section, a third parameter of each data point in the sub-section, wherein the third parameter is an identity of a nearest other data point within the sub-section, having a local density that is higher than the local density of the data point.

9. The method of claim 6, further comprising:
combining the computed plurality of parameters from the plurality of sub-sections, into a single matrix.

10. The method of claim 9, wherein running the statistical tests on each of the first parameter and the second parameter comprises running the statistical tests on the single matrix.

11. The method of claim 6, wherein the computations for the plurality of sub-sections are performed in parallel.

12. The method of claim 1, wherein the local density of the data point comprises a summation of a plurality of distance variables, each distance variable of the plurality of distance variables indicative of a distance between the data point and a respective other data point in the dataset.

13. The method of claim 12, wherein each distance variable comprises an exponential function, wherein an exponent of the exponential function comprises a function of the distance between the data point and the respective other data point in the dataset.

14. The method of claim 1, wherein determining the plurality of parameters of each data point in the dataset comprises applying a dimensionality reduction algorithm on the dataset, to generate a reduced dimensionality dataset.

15. The method of claim 14, wherein determining the plurality of parameters of each data point in the dataset further comprises determining the plurality of parameters based on the reduced dimensionality dataset.

16. The method of claim 14, wherein the dimensionality reduction algorithm is a non-linear dimensionality reduction algorithm.

17. The method of claim 16, wherein the dimensionality reduction algorithm is t-distributed stochastic neighbor embedding algorithm.

18. The method of claim 1, further comprising:
for each data point that is not one of the centers of clusters:
assigning the data point to the cluster of the nearest other data point having the local density that is higher than the local density of the data point.

19. A method of analyzing cytometry data with the aid of a computer, the method comprising:
providing the computer with a dataset comprising the cytometry data;
using the computer to identify clusters in the cytometry data, the clusters indicative of cell sub-populations, wherein identifying the clusters comprises:
determining for each data point in the dataset, a plurality of parameters comprising a first parameter and a second parameter,
the first parameter being a distance between the data point and a nearest other data point having a local density that is higher than a local density of the data point, and
the second parameter being a function of the local density of the data point and the first parameter;
running statistical tests on each of the first parameter and the second parameter across the dataset, to identify outliers of the first parameter and outliers of the second parameter; and
designating each data point where both the first parameter and the second parameter are identified outliers, as a centre of a respective cluster.

20. A method of detecting cell sub-populations in a plurality of cells, the method comprising:
performing cytometry on the plurality of cells to detect signals for each cell of the plurality of cells;
recording in a dataset, the detected signals for the plurality of cells such that each data point in the dataset is associated with one cell of the plurality of cells;
determining for each data point in the dataset, a plurality of parameters comprising a first parameter and a second parameter,
the first parameter being a distance between the data point and a nearest other data point having a local density that is higher than a local density of the data point, and
the second parameter being a function of the local density of the data point and the first parameter;
running statistical tests on each of the first parameter and the second parameter across the dataset, to identify outliers of the first parameter and outliers of the second parameter; and
designating each data point where both the first parameter and the second parameter are identified outliers, as a centre of a respective cluster, wherein each cluster is indicative of a cell sub-population.
